(19) United States
(12) Patent Application Publication
(10) Pub. No.: US 2026/0131379 A1
(43) Pub. Date: May 14, 2026

(54) METHOD FOR MANUFACTURING ROTOR

(71) Applicant: SHIMADZU CORPORATION, Kyoto (JP)

(72) Inventor: Hiroaki KIMURA, Kyoto (JP)

(73) Assignee: SHIMADZU CORPORATION, Kyoto (JP)

(21) Appl. No.: 19/383,847

(22) Filed: Nov. 10, 2025

(30) Foreign Application Priority Data
Nov. 13, 2024 (JP) 2024-198192

(51) Int. Cl. B22F 7/08; B33Y 40/00; B33Y 80/00; F04D 29/26

(52) U.S. Cl. CPC B22F 7/08; B33Y 40/00; B33Y 80/00; F04D 29/26

(57) ABSTRACT

A method for manufacturing a rotor comprises forming a first portion including at least a part of a rotor cylindrical portion of the rotor by mechanical processing, and forming a second portion including rotor blades by laminating onto the first portion.

This application claims priority under 35 U.S.C. § 119 to Japanese Patent Application No. 2024-198192 filed on November 13, 2024. The entire disclosure of Japanese Patent Application No. 2024-198192 is hereby incorporated herein by reference.

### TECHNICAL FIELD

The present invention relates to a method for manufacturing a rotor for a vacuum pump.

### BACKGROUND ART

Some vacuum pumps include a rotor that has rotor blades and a rotor cylindrical portion and is rotationally driven (see, for example, Patent Literature 1). In this vacuum pump, the rotor is rotated to suck the inside of a device to be evacuated, and the sucked gas is discharged to the outside.

### PRIOR ART DOCUMENTS

### PATENT LITERATURE

[Patent Literature 1] Japanese Unexamined Patent Application Publication No. 2021-139361

### SUMMARY OF INVENTION

### PROBLEM TO BE SOLVED BY THE INVENTION

Conventionally, constituent elements of a rotor, such as rotor blades, have been manufactured by forming a metal ingot (for example, a forged material) through mechanical processing such as cutting (machining). In the manufacturing of a rotor by mechanical processing, there have been problems in that machining chips are generated and the processing time becomes long, particularly due to the complex shape of the portion where the rotor blades are provided.

In order to solve such problems in the manufacturing of a rotor by mechanical processing, it is conceivable to manufacture the rotor using a molding method based on lamination of materials (for example, an additive manufacturing method). In the molding method based on lamination of materials, an object of an arbitrary shape can be formed by sequentially laminating layers of material. Even when the entire rotor is manufactured by the above-mentioned molding method, problems arise such as the manufacturing time for the rotor becoming long because the rotor is formed by sequentially laminating the material, and the manufacturing cost of the rotor becoming high because a large amount of material to be laminated is required.

Accordingly, an object of the present invention is to manufacture a rotor for a vacuum pump in a short time while suppressing waste of material.

### MEANS FOR SOLVING THE PROBLEM

A method for manufacturing a rotor according to one aspect of the present invention is a method for manufacturing a rotor having rotor blades and a rotor cylindrical portion. The method for manufacturing the rotor includes:

(a) Forming a first portion including at least a part of the rotor cylindrical portion by mechanical processing.

(b) Forming a second portion including the rotor blades by laminating onto the first portion.

### EFFECTS OF THE INVENTION

In the method for manufacturing a rotor used in a vacuum pump, a first portion including at least a part of the rotor cylindrical portion of the rotor is formed by mechanical processing, and the remaining portion of the rotor, that is, a second portion including the rotor blades, is formed by laminating onto the first portion. The first portion including at least a part of the rotor cylindrical portion has a simple shape, and thus can be easily and quickly formed by mechanical processing. On the other hand, the second portion including the rotor blades has a complex shape, but can be easily formed by a method of laminating onto the first portion. When the entire rotor is formed by a lamination method, a long time and a large amount of material are required for formation, but by forming only the second portion by lamination, the processing time can be shortened. Furthermore, since a large amount of material is not required, the manufacturing cost of the rotor can be reduced.

As described above, in the manufacturing of the rotor, by dividing the portion to be formed by mechanical processing (the first portion) and the portion to be formed by lamination (the second portion), the rotor can be manufactured easily and in a short time while reducing machining chips, as compared with the case where the entire rotor is formed by mechanical processing. Furthermore, compared with the case where the entire rotor is formed by lamination, the rotor can be manufactured in a shorter time and at a lower cost.

### BRIEF DESCRIPTION OF THE DRAWINGS

FIG. 1 is a cross-sectional view of a vacuum pump.

FIG. 2 is a diagram for explaining the portions constituting a rotor.

FIG. 3 is a diagram showing an example of an additive manufacturing apparatus.

FIG. 4 is a flowchart showing a method for manufacturing a rotor.

FIG. 5A is a diagram showing an example of the formation of a first portion.

FIG. 5B is a diagram schematically showing a process in which a second portion is formed by lamination of a first material (Part 1).

FIG. 5C is a diagram schematically showing a process in which a second portion is formed by lamination of a first material (Part 2).

FIG. 5D is a diagram schematically showing a process in which a second portion is formed by lamination of a first material (Part 3).

FIG. 6 is a diagram showing another embodiment of the first portion.

### DESCRIPTION OF EMBODIMENTS

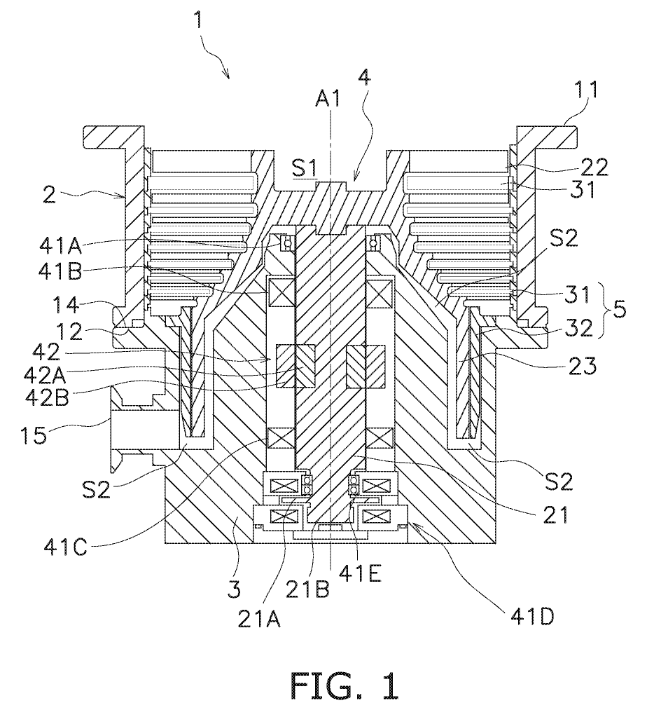

Hereinafter, a rotor used in a vacuum pump and a method for manufacturing the rotor will be described. First, a vacuum pump including a rotor will be described with reference to FIG. 1. FIG. 1 is a cross-sectional view of a vacuum pump 1. The vacuum pump 1 includes a housing 2, a base 3, a rotor 4, and a stator 5.

The housing 2 includes a first end portion 11, a second end portion 12, and a first internal space S1. An intake port 13 is provided at the first end portion 11. The intake port 13 is connected to the inside of a device to be evacuated (not shown) so as to allow gas to flow therethrough. The first internal space S1 communicates with the intake port 13. The second end portion 12 is located on the opposite side of the first end portion 11 in the axial direction of the rotor 4 (hereinafter, simply referred to as "axial direction A1"). The second end portion 12 is connected to the base 3. The base 3 includes a base end portion 14. The base end portion 14 is connected to the second end portion 12 of the housing 2.

The rotor 4 is housed in the internal space of the housing 2. The rotor 4 is attached to one end of a shaft 21. The shaft 21 extends in the axial direction A1. The shaft 21 is rotatably housed in the base 3. That is, the rotor 4 rotates due to the rotation of the shaft 21. A thrust disk 21A is provided at a lower part of the shaft 21. Furthermore, a target 21B is screwed to the lower end of the shaft 21.

The rotor 4 includes a plurality of stages of rotor blades 22 and a rotor cylindrical portion 23. The plurality of stages of rotor blades 22 are each connected to the shaft 21 so as to be inclined with respect to the axial direction A1. The plurality of stages of rotor blades 22 are arranged at intervals from each other in the axial direction A1. Although not shown, the plurality of stages of rotor blades 22 each extend radially with the shaft 21 as a center. In the drawings, only one of the plurality of stages of rotor blades 22 is denoted by a reference sign, and the reference signs of the other rotor blades 22 are omitted. The rotor cylindrical portion 23 is disposed below the plurality of stages of rotor blades 22. The rotor cylindrical portion 23 extends in the axial direction A1.

The stator 5 is disposed on the outer peripheral side of the rotor 4. The stator 5 includes a plurality of stages of stator blades 31 and a stator cylindrical portion 32. The plurality of stages of stator blades 31 are each connected to the inner surface of the housing 2 so as to be inclined in a direction opposite to the inclination of the rotor blades 22. For example, when the rotor blades 22 are inclined from the intake side to the exhaust side, the stator blades 31 are inclined from the exhaust side to the intake side. On the other hand, when the rotor blades 22 are inclined from the exhaust side to the intake side, the stator blades 31 are inclined from the intake side to the exhaust side. The inclination direction of the rotor blades 22 and the stator blades 31 can be appropriately determined according to the rotation direction of the rotor 4, and the like.

The plurality of stages of stator blades 31 are arranged at intervals from each other in the axial direction A1. The plurality of stages of stator blades 31 are respectively disposed between the plurality of stages of rotor blades 22. Although not shown, the plurality of stages of stator blades 31 each extend radially with the shaft 21 as a center. In the drawings, only two of the plurality of stages of stator blades 31 are denoted by reference signs, and the reference signs of the other stator blades 31 are omitted. The stator cylindrical portion 32 is fixed in a state of being in contact with the base 3. The stator cylindrical portion 32 is disposed facing the outer peripheral surface of the rotor cylindrical portion 23 with a slight gap therebetween in the radial direction of the rotor cylindrical portion 23. A spiral groove is provided on the inner peripheral surface of the stator cylindrical portion 32 that faces the rotor cylindrical portion 23.

As shown in FIG. 1, an exhaust space S2 is formed further downstream of the exhaust downstream ends of the rotor cylindrical portion 23 and the stator cylindrical portion 32. The gas to be evacuated, which has been exhausted from the device to be evacuated, is guided to the exhaust space S2. The exhaust space S2 communicates with an exhaust port 15. The exhaust port 15 is provided in the base 3. Another vacuum pump (not shown) is connected to the exhaust port 15. The term "exhaust downstream side" refers to the side closer to the exhaust space S2 in the axial direction A1. The term "exhaust downstream direction" refers to the direction toward the exhaust space S2.

The vacuum pump 1 includes bearings 41A and 41E, magnetic bearings 41B to 41D, and a motor 42. The bearings 41A and 41E are attached to the base 3 at positions where the shaft 21 is housed. The bearings 41A and 41E rotatably support the shaft 21. The bearings 41A and 41E are ball bearings. The magnetic bearings 41B to 41D are bearings that support the shaft 21 by magnetic force. Among these, the magnetic bearings 41B and 41C are radial magnetic bearings that support the shaft 21 in the radial direction. The magnetic bearing 41D is a thrust magnetic bearing that supports the shaft 21 in the axial direction.

The motor 42 rotationally drives the shaft 21 to thereby rotationally drive the rotor 4. The motor 42 includes a motor rotor 42A and a motor stator 42B. The motor rotor 42A is attached to the shaft 21. The motor stator 42B is attached to the base 3. The motor stator 42B is disposed so as to face the motor rotor 42A.

In the vacuum pump 1, the plurality of stages of rotor blades 22 and the plurality of stages of stator blades 31 constitute a turbo-molecular pump section. Further, the rotor cylindrical portion 23 and the stator cylindrical portion 32 constitute a thread groove pump section. In the vacuum pump 1, when the rotor 4 is rotated by the motor 42, gas to be evacuated flows from the inside of the device to be evacuated into the first internal space S1 via the intake port 13. The gas to be evacuated in the first internal space S1 passes through the turbo-molecular pump section and the thread groove pump section and is guided to the exhaust space S2. The gas to be evacuated in the exhaust space S2 is exhausted from the exhaust port 15. As a result, the inside of the device to be evacuated attached to the intake port 13 is brought into a high vacuum state.

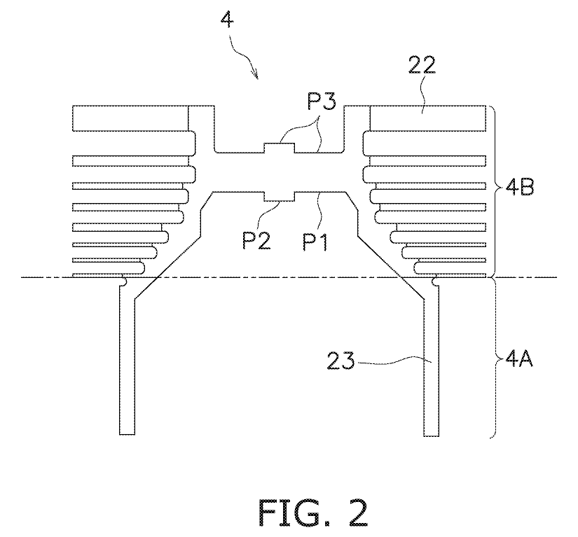

Hereinafter, the rotor 4 will be described in detail. As shown in FIG. 2, the rotor 4 has a first portion 4A and a second portion 4B. FIG. 2 is a diagram for explaining the portions constituting the rotor 4. In the present embodiment, the first portion 4A is a portion from the lower end of the rotor cylindrical portion 23 to a connection point between the rotor cylindrical portion 23 and the lowermost stage rotor blade 22. That is, the first portion 4A is a portion corresponding to the rotor cylindrical portion 23. The second portion 4B is a portion from the lowermost stage rotor blade 22 to the upper end of the rotor 4. That is, the second portion 4B is a portion including the plurality of stages of rotor blades 22.

The rotor 4 is made of a titanium-based material. Examples of the titanium-based material used for the rotor 4 include titanium, titanium alloys, and the like. In the present embodiment, an alloy containing about 6% by mass of aluminum and about 4% by mass of vanadium in titanium (alloy) (sometimes referred to as "64 titanium") can be used as the material for the rotor 4. The rotor 4 made of a titanium-based material is lightweight and has extremely high strength. For this reason, in the vacuum pump 1, the rotor 4 can be rotated at a higher speed, and the performance can be significantly improved as compared with the conventional vacuum pump 1.

A titanium-based material is difficult to process by a mechanical processing method using a tool having a cutting edge, such as cutting. On the other hand, the additive manufacturing method is a method of forming an article of a desired shape by irradiating a powder of metal or the like with a laser beam, an electron beam, or the like according to a desired shape, thereby melting and fixing the powder. Therefore, even with a titanium-based material, an article having a complicated shape can be easily formed.

Therefore, the first portion 4A, which has a substantially cylindrical and simple shape, can be formed relatively easily and in a short time even by mechanical processing. On the other hand, the second portion 4B, which has a complicated shape including the plurality of stages of rotor blades 22, can be formed relatively easily by an additive manufacturing method. Although it is difficult to increase the formation speed in the additive manufacturing method because an article is formed by sequentially laminating powder, by using the additive manufacturing method only for the second portion 4B and not for the entire rotor 4, the second portion 4B can be formed in a relatively short time as compared with the case where the entire rotor 4 is formed by the additive manufacturing method. Furthermore, since the amount of powder material to be laminated can be saved, the manufacturing cost of the rotor 4 can be reduced as compared with the case where the entire rotor 4 is formed by the additive manufacturing method.

As described above, in the manufacturing of the rotor 4, by dividing the portion to be formed by mechanical processing (the first portion 4A) and the portion to be formed by lamination of a material (the second portion 4B), the rotor 4 can be manufactured easily and in a short time while reducing machining chips, as compared with the case where the entire rotor 4 is formed by mechanical processing. Furthermore, compared with the case where the entire rotor 4 is formed by an additive manufacturing method, the rotor 4 can be manufactured in a shorter time and at a lower cost.

Furthermore, by forming a part of the rotor 4 by mechanical processing instead of forming the entire rotor 4 by an additive manufacturing method, a machining origin for forming the second portion 4B by the additive manufacturing method and for various types of processing can be accurately determined. The machining origin is determined based on the surface of the object to be processed, but if the machining origin is determined on a portion formed by the additive manufacturing method, the machining origin cannot be determined accurately. This is because the surface of the portion formed by the additive manufacturing method has many irregularities, and the machining origin determined for that portion may vary depending on the determined position. In addition, this is because the additive manufacturing method cannot achieve the same dimensional accuracy as mechanical processing.

On the other hand, a portion formed by mechanical processing has few irregularities on its surface and high dimensional accuracy. Therefore, by determining the machining origin with reference to any position of the portion formed by mechanical processing (the first portion 4A), the machining origin can be accurately determined at the position where it should be.

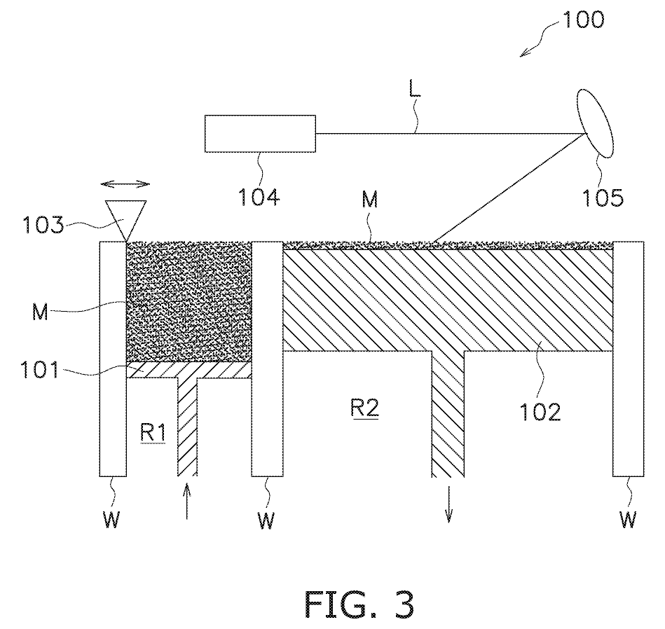

Hereinafter, the method for manufacturing the rotor 4 described above will be described. First, an example of an additive manufacturing apparatus 100 for forming the second portion 4B by an additive manufacturing method will be described with reference to FIG. 3. FIG. 3 is a diagram showing an example of the additive manufacturing apparatus 100. The additive manufacturing apparatus 100 has a first chamber R1 and a second chamber R2 formed by three walls W arranged at a predetermined interval.

A material placement portion 101 is disposed in the first chamber R1. The material placement portion 101 is movable in the vertical direction along the wall W in the first chamber R1. In the first chamber R1, a space from the upper end of the material placement portion 101 to slightly above the upper end of the wall W is filled with a first material M in powder form (in this embodiment, a powder of titanium alloy) used for forming the second portion 4B.

A processing target placement portion 102 is disposed in the second chamber R2. An object to be processed, on which the first material M is to be laminated, is placed on the processing target placement portion 102. In the processing target placement portion 102, the object to be processed is placed such that its upper end surface is located slightly below the upper end surface of the wall W. The processing target placement portion 102 is movable in the vertical direction along the wall W in the second chamber R2.

The additive manufacturing apparatus 100 has a material extrusion portion 103. The material extrusion portion 103 is movable in the horizontal direction, and pushes out the first material M, which is filled in the first chamber R1 and exists slightly above the upper end surface of the wall W, in the direction of the second chamber R2, and supplies it to the upper end surface of the object to be processed placed on the processing target placement portion 102.

The additive manufacturing apparatus 100 has an irradiation unit 104 and a mirror 105. The irradiation unit 104 generates a beam L that melts the powder of the first material M supplied to the upper end surface of the object to be processed. The beam L for melting the powder of the first material M is, for example, a laser beam. In this case, the irradiation unit 104 is a laser oscillator that generates a laser beam.

The mirror 105 reflects the beam L irradiated from the irradiation unit 104 toward the powder of the first material M supplied to the upper end surface of the object to be processed. The mirror 105 is rotatable around a plurality of axes (for example, a vertical axis and a horizontal axis) by, for example, a galvano scanner, and can reflect the beam L to an arbitrary position on the object to be processed. As described above, since the beam L can be irradiated to an arbitrary position on the object to be processed, the additive manufacturing apparatus 100 can form an article of an arbitrary shape.

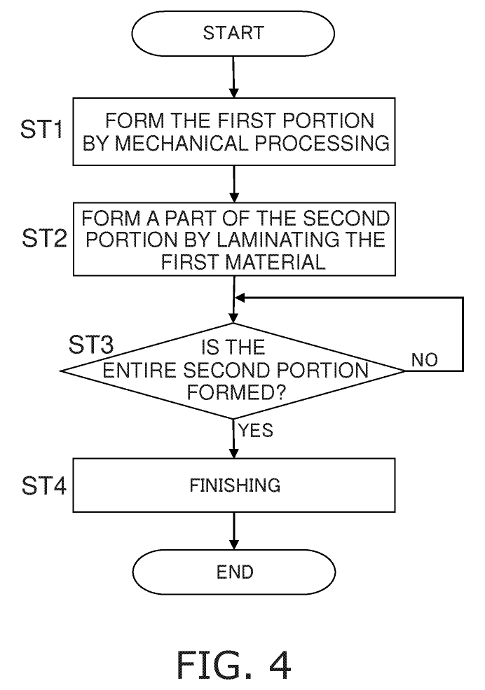

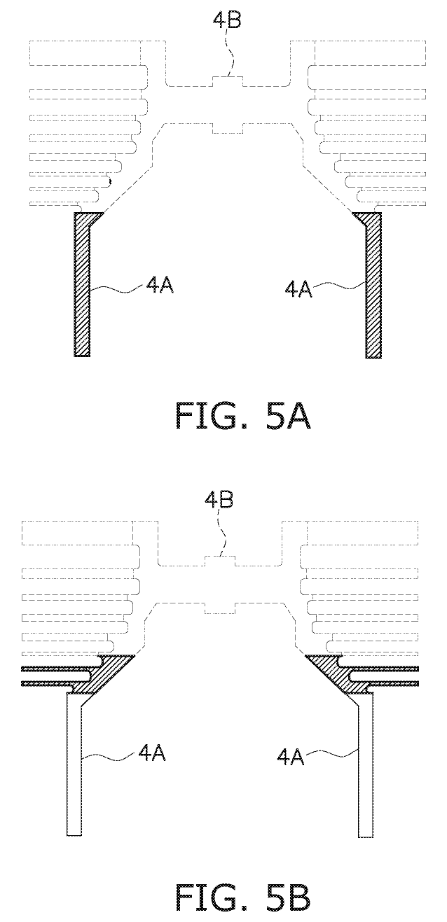

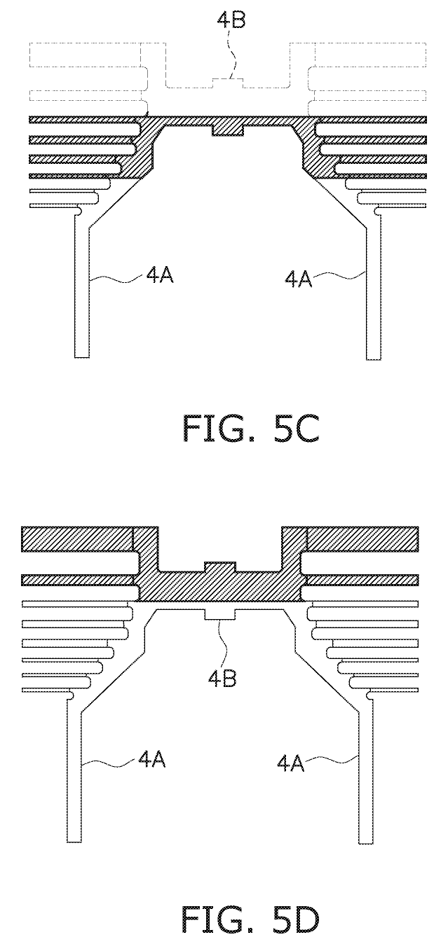

A method for manufacturing the rotor 4 will be specifically described with reference to FIG. 4. FIG. 4 is a flowchart showing the method for manufacturing the rotor 4. First, as shown in FIG. 5A, the first portion 4A of the rotor 4 is formed by cutting (step ST1). If necessary, holes are drilled at positions where parts are to be attached, and the like. FIG. 5A is a diagram showing an example of the formation of the first portion 4A. As shown in FIG. 5A, the first portion 4A has a cylindrical shape, and even when it is formed of a titanium-based material that is difficult to process, it can be formed relatively easily and in a short time by mechanical processing such as cutting.

Next, the second portion 4B is formed on the upper end of the first portion 4A formed in step ST1 by an additive manufacturing method (step ST2). Specifically, the second portion 4B is formed as follows. First, the first portion 4A formed in step ST1 is placed on the processing target placement portion 102 of the additive manufacturing apparatus 100. In the processing target placement portion 102, the first portion 4A is placed such that its upper end surface coincides with the upper end surface of the processing target placement portion 102. Further, the processing target placement portion 102 is placed such that its upper end surface is located slightly below the upper end surface of the wall W.

When the first portion 4A is placed on the processing target placement portion 102 as described above, a machining origin for forming the second portion 4B by the additive manufacturing method is determined, but in the case of the first portion 4A formed by mechanical processing, the machining origin can be determined accurately. As a result, improper formation of the second portion 4B, such as lamination displacement, can be prevented.

Thereafter, the material extrusion portion 103 of the additive manufacturing apparatus 100 is moved in the direction of the second chamber R2, and the first material M filled in the first chamber R1 is pushed out and supplied to the second chamber R2. As described above, the first portion 4A is placed such that its upper end surface coincides with the upper end surface of the processing target placement portion 102, and the upper end surface of the processing target placement portion 102 is located slightly below the upper end surface of the wall W. Therefore, when the first material M is supplied to the second chamber R2 by the material extrusion portion 103, the first material M is supplied to the upper end surfaces of the processing target placement portion 102 and the first portion 4A with a thickness corresponding to the distance between the upper end surfaces and the upper end surface of the wall W. That is, in one process of the additive manufacturing method, a part of the second portion 4B having a thickness corresponding to the distance between the upper end surface of the first portion 4A and the upper end surface of the wall W is formed on the upper end surface of the first portion 4A.

After the first material M is supplied to the upper end surfaces of the processing target placement portion 102 and the first portion 4A, a beam L is generated from the irradiation unit 104 and the mirror 105 is appropriately rotated, and in accordance with the shape (cross-sectional shape) of a part of the second portion 4B to be formed in the current process of the additive manufacturing method, the first material M on the upper end surfaces of the processing target placement portion 102 and the first portion 4A is irradiated with the beam L to melt and fix the first material M, thereby forming a part of the second portion 4B.

After a part of the second portion 4B is formed, the material extrusion portion 103 is returned to the end of the first chamber R1 (the left end in FIG. 3), and the material placement portion 101 of the first chamber R1 of the additive manufacturing apparatus 100 is raised to cause the first material M in the first chamber R1 to protrude above the upper end surface of the wall W. On the other hand, the processing target placement portion 102 is lowered to move the upper end surface of the part of the second portion 4B formed in the current process to a position slightly below the upper end surface of the wall W.

Thereafter, (i) supplying the first material M in the first chamber R1 to the upper end surface of the part of the second portion 4B (and the upper end surface of the processing target placement portion 102), (ii) irradiating with the beam L according to the shape of the part of the second portion 4B to melt and fix the first material M supplied to the upper end surface, and (iii) raising the material placement portion 101 of the additive manufacturing apparatus 100 and lowering the processing target placement portion 102 are repeatedly executed until the entire second portion 4B is formed (that is, "No" in step ST3). As a result, as shown in FIGS. 5B to 5D, the second portion 4B is sequentially formed from the upper end surface of the first portion 4A toward the upper end of the rotor 4 by lamination of the first material M.

In FIGS. 5A to 5D, the solid line portions (without internal hatching) indicate the already formed portions, the regions enclosed by thick solid lines and hatched with diagonal lines indicate the portions formed in the current process, and the broken line portions indicate the unformed portions. FIGS. 5B to 5D are diagrams schematically showing the process in which the second portion 4B is formed by lamination of the first material M.

After the second portion 4B is formed, finishing of the rotor 4 is performed (step ST4). Here, "finishing" is performed by mechanical processing, and is, for example, processing for eliminating irregularities on the surface of the rotor 4 (particularly the second portion 4B) and adjusting the dimensions of the rotor 4, using a lathe or the like. The finishing is performed, but not limited to, particularly on a contact portion with the shaft 21 (for example, a surface P1 (FIG. 2) that contacts the shaft 21, a protruding portion P2 (FIG. 2) that is fitted into the shaft 21), a mounting surface for various components (for example, a surface P3 (FIG. 2)), and the like. This is performed, for example, for the purpose of appropriate connection (fitting) between the rotor 4 and the shaft 21, balance adjustment of the rotor 4, and aligning the axis center of the shaft 21 and the center of the rotor 4 without error. Further, if necessary, processing for forming holes for attaching components (drilling) is performed as finishing.

For the above reasons, it is preferable that the finishing is performed after the machining origin is accurately determined. Therefore, when it is necessary to hold, place, or the like, the rotor 4 in finishing, the first portion 4A of the rotor 4, which is formed by mechanical processing, is held, placed, or the like. Furthermore, the machining origin is determined based on the surface of the first portion 4A formed by mechanical processing. For example, the position of a processing tool when it comes into contact with the surface of the first portion 4A can be determined as the machining origin.

By determining the machining origin for finishing based on the surface of the first portion 4A, the finishing of the rotor 4 can be performed according to intended dimensions, so that the rotor 4 and the shaft 21 can be appropriately connected, and a rotor 4 with little or no imbalance, deviation between the center of the shaft 21 and the center of the rotor 4, or the like can be manufactured.

Although one embodiment of the present invention has been described above, the present invention is not limited to the above-described embodiment, and various changes can be made without departing from the gist of the invention.

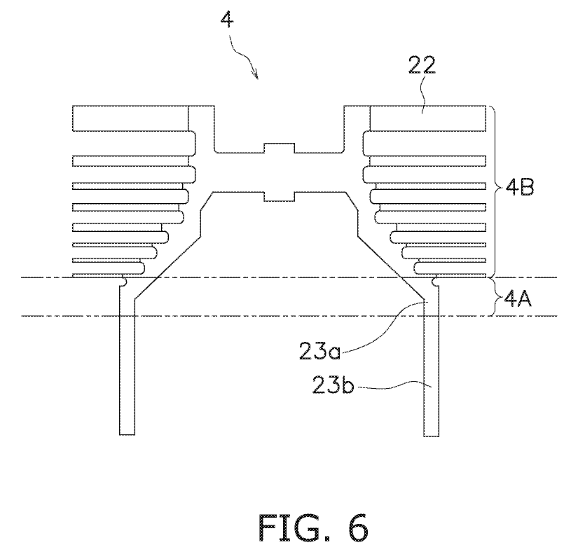

In the above-described embodiment, the first portion 4A of the rotor 4 is an entire rotor cylindrical portion 23. However, the present invention is not limited to this. For example, as shown in FIG. 6, a connection portion 23a of the rotor cylindrical portion 23 with the lowermost stage rotor blade 22 may be used as the first portion 4A. FIG. 6 is a diagram showing another embodiment of the first portion 4A. As a result, the vertical dimension of the first portion 4A can be reduced, so that the vertical dimension of the processing target placement portion 102 of the additive manufacturing apparatus 100 can be reduced. As described above, when the first portion 4A is placed on the processing target placement portion 102, it is necessary to make the upper end surface of the processing target placement portion 102 and the upper end surface of the first portion 4A coincide. For this reason, when the first portion 4A is the entire rotor cylindrical portion 23, it is necessary to make the vertical dimension of the processing target placement portion 102 the same as the dimension of the entire rotor cylindrical portion 23. On the other hand, if the first portion 4A is the connection portion 23a, the vertical dimension of the processing target placement portion 102 can be made smaller, the same as the dimension of the connection portion 23a, which is smaller than the entire rotor cylindrical portion 23.

Furthermore, when the first portion 4A is the connection portion 23a, the portion to be formed by mechanical processing can be reduced, so that the manufacturing time of the rotor 4 can be further shortened.

Furthermore, when the first portion 4A is the connection portion 23a, as shown in FIG. 6, the rotor cylindrical portion 23 can be formed by fixing another cylindrical portion 23b to the lower end of the connection portion 23a, which is the first portion 4A. In this way, by forming the rotor cylindrical portion 23 by separating it into the connection portion 23a and the cylindrical portion 23b, the rotor cylindrical portion 23 can be formed of a more optimal material. The cylindrical portion 23b can be made of a carbon material such as graphite, for example. By forming the cylindrical portion 23b of a carbon material, the weight of the rotor cylindrical portion 23 can be reduced (that is, the weight of the entire rotor 4 can be reduced).

In addition to the entire rotor cylindrical portion 23, several stages (about one or two stages) of the rotor blades 22 at the lowermost stage may be included in the first portion 4A formed by mechanical processing. With respect to the several stages of rotor blades 22 included in the first portion 4A, a processing tool can be brought relatively easily close to the portion where the rotor blades 22 are formed, so that the rotor blades 22 can be formed by mechanical processing.

A through-hole penetrating from the outer periphery to the inner periphery may be provided in the rotor cylindrical portion 23. As a result, the gas to be evacuated can be exhausted not only through the gap between the rotor cylindrical portion 23 and the outer periphery and the stator cylindrical portion 32, but also through the gap between the inner periphery of the rotor cylindrical portion 23 and the base 3. This through-hole can be formed by mechanical processing (drilling).

When forming the second portion 4B, the beam L irradiated to melt the powder of the first material M is not limited to a laser beam, and may be an electron beam.

The method for forming the second portion 4B is not limited to the method using the above-described additive manufacturing apparatus 100 (that is, the powder bed fusion method), and for example, a method of spraying powder of the first material M while irradiating with a laser beam or the like to laminate and solidify the first material M (directed energy deposition method), a method of extruding a molten first material M from a nozzle or the like to form the second portion 4B (ADAM method), a method of spraying a binder (liquid binding agent) onto powder of the first material M to solidify it (binder jetting method), or the like can be adopted.

The rotor 4 can also be made of another metal such as aluminum, depending on its application and the like. Even when another metal is used, the entire rotor 4 can be manufactured by forming the first portion 4A of the rotor 4 by mechanical processing and forming the second portion 4B by lamination of a material (additive manufacturing method), as described above.

Furthermore, the first portion 4A and the second portion 4B may be formed of different materials, for example, the first portion 4A may be formed of an aluminum alloy and the second portion 4B may be formed of a titanium alloy. For example, the first portion 4A may be formed of a first titanium alloy, and the second portion 4B may be formed of a second titanium alloy whose alloy components are different from those of the first titanium alloy. In other words, a titanium alloy suitable for mechanical processing may be selected as the first titanium alloy, and a titanium alloy suitable for an additive manufacturing method may be selected as the second titanium alloy.

Those skilled in the art will understand that the plurality of exemplary embodiments described above are specific examples of the following aspects.

(First Aspect) A method for manufacturing a rotor (for example, rotor 4) having rotor blades (for example, rotor blades 22) and a rotor cylindrical portion (for example, rotor cylindrical portion 23) includes (a) and (b) below. The order of execution of (a) and (b) below is not limited.

(a) Forming a first portion (for example, first portion 4A) including at least a part of the rotor cylindrical portion by mechanical processing (for example, step ST1).

(b) Forming a second portion (for example, second portion 4B) including the rotor blades by laminating onto the first portion (for example, steps ST2-ST3).

In the method for manufacturing a rotor according to the first aspect, a first portion including at least a part of the rotor cylindrical portion of the rotor is formed by mechanical processing, and the remaining portion of the rotor, that is, a second portion including the rotor blades, is formed by laminating onto the first portion. The first portion including at least a part of the rotor cylindrical portion has a simple shape, and thus can be easily and quickly formed by mechanical processing. On the other hand, the second portion including the rotor blades has a complex shape, but can be easily formed by a method of laminating onto the first portion. When the entire rotor is formed by a lamination method, a long time and a large amount of material are required for formation, but by forming only the second portion by lamination, the processing time can be shortened. Furthermore, since a large amount of material is not required, the manufacturing cost of the rotor can be reduced.

As described above, in the manufacturing of the rotor, by dividing the portion to be formed by mechanical processing (the first portion) and the portion to be formed by lamination (the second portion), the rotor can be manufactured easily and in a short time while reducing machining chips, as compared with the case where the entire rotor is formed by mechanical processing. Furthermore, compared with the case where the entire rotor is formed by lamination, the rotor can be manufactured in a shorter time and at a lower cost.

(Second Aspect) In the method for manufacturing a rotor according to the first aspect, the first material (for example, first material M) to be laminated on the first portion may be a titanium-based material. In the method for manufacturing a rotor according to the second aspect, since a rotor that is lightweight and has extremely high strength can be manufactured, the performance of the vacuum pump can be greatly improved, for example, by enabling the rotor to be rotated at a higher speed, as compared with a conventional vacuum pump. Further, although a titanium-based material is difficult to process by a mechanical processing method, if a lamination method is used, even if the first material, which is the material to be laminated to form the second portion, is a titanium-based material, the second portion having a complicated shape can be easily formed.

(Third Aspect) The method for manufacturing a rotor according to the first or second aspect may further comprise finishing at least the second portion by setting a machining origin with reference to the first portion formed by mechanical processing (for example, step ST4). In the method for manufacturing a rotor according to the third aspect, the finishing of the rotor can be performed according to intended dimensions, so that a rotor with little or no imbalance, deviation of the center of the rotor 4, or the like can be manufactured.

(Fourth Aspect) In the method for manufacturing a rotor according to any one of the first to third aspects, the first portion may be an entire rotor cylindrical portion. In the method for manufacturing a rotor according to the fourth aspect, the entire rotor cylinder portion can be formed with high accuracy.

(Fifth Aspect) In the method for manufacturing a rotor according to any one of the first to third aspects, the first portion may be a portion of the rotor cylindrical portion that is connected to the rotor blades (for example, connection portion 23a). In the method for manufacturing a rotor according to the fifth aspect, the dimension of a portion (for example, processing target placement portion 102) of an apparatus for forming the second portion (for example, additive manufacturing apparatus 100) on which the first portion is placed can be reduced. Furthermore, since the portion to be formed by mechanical processing can be reduced, the manufacturing time of the rotor can be further shortened.

(Sixth Aspect) The method for manufacturing a rotor according to the fifth aspect may further comprise forming the rotor cylindrical portion by attaching a predetermined member (for example, cylindrical portion 23b) to the first portion. In the method for manufacturing a rotor according to the sixth aspect, the rotor cylindrical portion can be formed of a more optimal material.

(Seventh Aspect) In the method for manufacturing a rotor according to the sixth aspect, the predetermined member may be made of a carbon material. In the method for manufacturing a rotor according to the seventh aspect, the weight of the rotor cylindrical portion can be reduced (that is, the weight of the rotor can be reduced).

### REFERENCE SIGNS LIST

1: Vacuum pump

2: Housing

3: Base

4: Rotor

5: Stator

11: First end portion

12: Second end portion

13: Intake port

14: Base end portion

15: Exhaust port

21: Shaft

21A: Thrust disk

21B: Target

22: Rotor blade

22a: Center portion

22b: Blade

221: First portion

223: Second portion

225: Connection portion

227: Curved portion

M1: First material

M2: Second material

23: Rotor cylindrical portion

31: Stator blade

32: Stator cylindrical portion

41A: Bearing

41B: Magnetic bearing

41C: Magnetic bearing

41D: Magnetic bearing

41E: Bearing

42: Motor

42A: Motor rotor

42B: Motor stator

A1: Axial direction

S1: First internal space

S2: Exhaust space

1. A method for manufacturing a rotor having a rotor blade and a rotor cylindrical portion, the method comprising:
forming a first portion including at least a part of the rotor cylindrical portion by mechanical processing; and
forming a second portion including the rotor blade by laminating onto the first portion.

2. The method for manufacturing a rotor according to claim 1, wherein a first material to be laminated on the first portion is a titanium-based material.

3. The method for manufacturing a rotor according to claim 1, further comprising finishing at least the second portion by setting a machining origin with reference to the first portion formed by mechanical processing.

4. The method for manufacturing a rotor according to claim 1, wherein the first portion is an entire rotor cylindrical portion.

5. The method for manufacturing a rotor according to claim 1, wherein the first portion is a portion of the rotor cylindrical portion that is connected to the rotor blade.

6. The method for manufacturing a rotor according to claim 5, further comprising forming the rotor cylindrical portion by attaching a predetermined member to the first portion.

7. The method for manufacturing a rotor according to claim 6, wherein the predetermined member is made of a carbon material.
